(19) United States
(12) Patent Application Publication
(10) Pub. No.: US 2019/0018841 A1
(43) Pub. Date: Jan. 17, 2019

(54) TERM EXTRACTION METHOD AND APPARATUS

(71) Applicant: ALIBABA GROUP HOLDING LIMITED, George Town (KY)

(72) Inventor: Zengming ZHANG, Hangzhou (CN)

(73) Assignee: ALIBABA GROUP HOLDING LIMITED

(21) Appl. No.: 16/133,640

(22) Filed: Sep. 17, 2018

Related U.S. Application Data
(63) Continuation of application No. PCT/CN2017/075832, filed on Mar. 7, 2017.

(30) Foreign Application Priority Data
Mar. 17, 2016 (CN) 201610153177.4

(51) Int. Cl. G06F 17/27; G06F 17/30

(52) U.S. Cl. CPC G06F 17/2785; G06F 17/273; G06F 17/30563; G06F 17/2735; G06F 17/274

(57) ABSTRACT

The present disclosure provides term extraction methods and apparatuses. One exemplary method comprises: acquiring description information of a network resource; performing an explicit-term extraction procedure on the description information to extract an explicit term from the description information; and performing a mode-term extraction procedure on the description information to extract an implicit term from the description information. Based on the technical solution of the present disclosure, both explicit terms that are easily discoverable and implicit terms that are not easily discoverable can be automatically extracted from the description information. The extraction can be more comprehensive, and the extraction quality can be improved.

This application claims priority to International Application No. PCT/CN2017/075832, filed on Mar. 7, 2017, which claims priority to and the benefits of priority to Chinese Application No. 201610153177.4, filed on Mar. 17, 2016, both of which are incorporated herein by reference in their entireties.

### TECHNICAL FIELD

The present disclosure relates to the field of data processing technologies, and in particular, to term extraction methods and apparatuses.

### BACKGROUND

With the development of Internet technologies, there is an increasing amount of information that are processed in information processing related technology fields. Term extraction is an important technique in information processing technologies, such as search engines, automatic word segmentation, dictionary compilation, and machine translation. Performance of term extraction can have a great impact on information processing in such fields. Further, different linguistic styles may be used in different fields, which may require different term extraction techniques.

Taking online information about clothing as an example, terms may be used to describe the features of the clothing items. A piece of clothing may be described by terms such as “long-sleeve,” “v-neck,” “black,” and “package-hip.” In existing techniques, such descriptive terms may need to be manually determined by operation personnel based on their experience. Because of limited personal knowledge of the operation personnel, terms determined in such a manner are not comprehensive and accuracy of such determination cannot be ensured.

### SUMMARY

In view of the above problems, the present disclosure provides term extraction methods and apparatuses. One objective of the embodiments of the present disclosure is to improve extraction quality.

According some embodiments of the present disclosure, term extraction methods are provided. One exemplary method comprises: acquiring description information of a network resource; performing an explicit-term extraction procedure on the description information to extract an explicit term from the description information; and performing a mode-term extraction procedure on the description information to extract an implicit term from the description information.

According to some embodiments of the present disclosure, term extraction apparatuses are provided. One exemplary apparatus comprises: an acquisition module configured to acquire description information of a network resource; a first extraction module configured to perform an explicit-term extraction procedure on the description information to extract an explicit term from the description information; and a second extraction module configured to perform a mode-term extraction procedure on the description information to extract an implicit term from the description information.

By the technical solutions provided by the present disclosure, description information of a network resource can be used as a corpus for term extraction. An explicit-term extraction procedure and a mode-term extraction procedure can be performed on the description information. That way, explicit terms that can be easily discovered are extracted. Implicit terms that are not easily discoverable can also be extracted from the description information. More comprehensive term extraction can be achieved, and extraction quality can be ensured.

### BRIEF DESCRIPTION OF THE DRAWINGS

To further describe the technical solutions in the embodiments of the present disclosure, the following provides a brief introduction of the accompanying drawings. It is appreciated that the accompanying drawings are only exemplary illustration of some embodiments of the present disclosure. Other drawings can be obtained based on the present disclosure.

FIG. 1 is a schematic flowchart of an exemplary term extraction method according to some embodiments of the present disclosure.

FIG. 2 is a schematic flowchart of an exemplary term extraction method according to some embodiments of the present disclosure.

FIG. 3 is a schematic structural diagram of an exemplary term extraction apparatus according to some embodiments of the present disclosure.

FIG. 4 is a schematic structural diagram of an exemplary term extraction apparatus according to some embodiments of the present disclosure.

### DETAILED DESCRIPTION

To describe the objectives, technical solutions, and advantages of the embodiments of the present disclosure in more detail, some exemplary technical solutions according to some embodiments of the present disclosure are described below with reference to the accompanying drawings. It is appreciated that the embodiments described herein are merely some exemplary embodiments. Consistent with the present disclosure, other embodiments can be obtained without departing from the principles disclosed herein. Such embodiments shall also fall within the protection scope of the present disclosure.

Terms that describe features of items can be extracted for information processing. In existing techniques, terms are generally determined manually by operation personnel based on their experience. Due to limited personal knowledge and subjective judgement of the operation personnel, terms determined in such a manner are not comprehensive and the extraction quality cannot be ensured.

In view of such problems, the present disclosure provides term extraction methods. According to the methods provided in the present disclosure, description information of a network resource can be used as a corpus for term extraction. Both explicit terms that are easily discoverable and implicit terms that are not easily discoverable can be automatically extracted from the description information. The extraction can be more comprehensive, and the extraction quality can be improved.

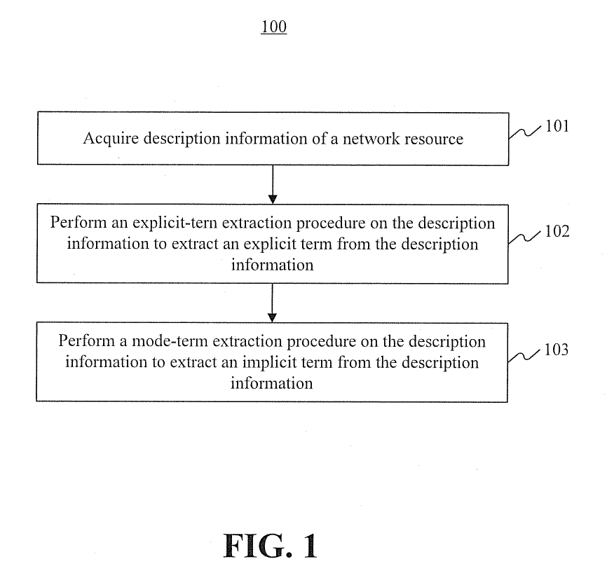

FIG. 1 is a schematic flowchart of an exemplary term extraction method 100 according to some embodiments of the present disclosure. As shown in FIG. 1, the exemplary method 100 can include the following procedures:

In step 101, description information of a network resource is acquired.

In step 102, an explicit-term extraction procedure is performed on the description information to extract an explicit term from the description information.

In step 103, a mode-term extraction procedure is performed on the description information to extract an implicit term from the description information.

The term extraction methods provided in the present disclosure can be performed by a term extraction apparatus, to ensure comprehensive extraction and high extraction quality.

In some embodiments, the extraction process may start with preparing an extraction corpus. For example, the description information of the network resource, as described above, can be acquired and used as the extraction corpus. The description information of the network resource can be information related to the network resource. For example, the description information may include, but is not limited to, at least one of a title, attribute information, keywords, detailed information, and comment information associated with the network resource. It is appreciated that the description information of the network resource can include, but is not limited to, text information.

The attribute information of the network resource may be manually filled in by a network resource provider during the release of the network resource. For example, the attribute information can include, but is not limited to, a length, a size, a place of origin, a style, and a decoration. The title and keywords associated with the network resource may also be manually filled in by the network resource provider during the release of the network resource. In some embodiments, such as in the field of electronic commerce, the network resource may be a product or a service. A product is used herein as an example in the following description of some embodiments. In such examples, the title, attribute information, and keywords of the network resource can include a title, attribute information, and keywords of the product.

It is appreciated that in terms of big data processing, the description information of the network resource can be massive, and there may be hundreds of millions of data items. According to some embodiments of the present disclosure, terms can be extracted based on massive description information. Automatic term extraction can be achieved, and consumption of manual labor can be reduced.

In some embodiments, considering that information in a data warehouse is relatively regular and has relatively high quality, the description information of the network resource can be acquired from a data warehouse. For example, the network resource can be a product, and the description information can include a title, attribute information, and keywords of the product. The title, the attribute information, and the keywords of the product can be acquired from the data warehouse. The title, the attribute information, and the keywords of the product extracted from the data warehouse can include the following.

For example, the title of the product can be: Sexy style girls' black dress package-hip-dress one-shoulder long-sleeve green flower v-neck o-neck cocktail dress wholesale-retail free shipping 100% cotton

The attribute information of the product can be as follows: Length: floor-length|Decoration: beading|Gender: woman|Season: summer|Pattern Type: print|Sleeve Style: off the shoulder|Neckline: o-neck|Style: casual|Place of Origin: Fujian, China Mainland|Number: LC2132-1 LC2132-2 LC2132-3

The keywords (separated by commas) of the product can be as follows: Blue Dress Party, Fashion Ladies Blue Dress Party, Fashion Ladies Blue Dress Party

In some embodiments, the description information of the network resource may include some irregularities and errors. For example, strange symbols may be used to connect words, a plurality of words may be written together and cannot be properly separated, words may be misspelled, and the same word or phrase may have different forms when used in different positions. Accordingly, if the description information is used directly for extraction, subsequent processing may be more difficult and the quality of term extraction may be compromised. In view of this, the process of acquiring the description information of the network resource can include: extracting original description information of the network resource from the data warehouse, and performing text preprocessing on the original description information to acquire preprocessed description information.

The process of performing text preprocessing on the original description information can include, but is not limited to, performing at least one of the following on the original description information: connecting-symbol retention processing, case conversion processing, spelling consistency check processing, word segmentation processing, spelling correction processing, and noun lemmatization processing.

An example of connecting-symbol retention processing is as follows. Some strange connecting symbols such as a plus sign “+” may exist in the original description information. The original description information may become relatively regular after these strange connecting symbols are removed, thereby facilitating subsequent processing. However, some special connecting symbols may be used to express special or additional meanings. For example, a hyphen “-” may be added when a network resource provider fills in description information of a network resource. The symbol may be used to connect two or more related words. The network resource provider may want to connect these words together to express a richer semantic meaning. For example, “o-neck” is a correct spelling and expresses the meaning of a “round neckline.” If the hyphen “-” is removed, a misspelling “oneck” is obtained. It may be corrected to “neck” in subsequent correction processing. As a result, its original meaning is lost.

As another example, the percent sign “%” may be used to represent component content. For example, the percent sign in “100% cotton” represents the cotton content is one hundred percent, and therefore should be retained. In some other cases, a percent sign that is not necessary and can be removed. For example, the percent sign in “v-neck %” does not need to be retained and can be deleted.

As yet another example, the single quotation mark “′” may be used to express a possessive relationship in some cases. For example, the single quotation mark in “girls” represents a possessive relationship and should therefore be retained. In some other cases, a single quotation mark may not be necessary and should be removed. For example, the single quotation mark in “shoulder′” is redundant and can be deleted.

Based on the foregoing, formats that need to be retained may be designated in advance for symbols such as a hyphen, a single quotation mark, or a percent sign. During the connecting-symbol retention processing performed on the original description information, it may be determined whether the original description information includes a hyphen, a single quotation mark, or a percent sign that conforms to a designated format. If the inclusion of such symbols conforms to a designated format, the hyphen, single quotation mark, or percent sign that conforms to the designated format can be retained. A hyphen, a single quotation mark, a percent sign, or another connecting symbol that exists in the original description information but does not conform to the designated formats can be deleted.

For example, a title of a product before connecting-symbol retention processing can be as follows: SEXY style girls' black dresses package-hip-dress one shouder' longSLEEVE++Green flowers+v-neck % oneck COCKAIL DR-ESS+wholesale and retail+free shipping 100% cotton

After the connecting-symbol retention processing, the title can be as follows: SEXY style girls' black dresses package-hip-dress one shouder longSLEEVE Green flowers v-neck oneck COCKAIL DR-ESS wholesale and retail free shipping 100% cotton

It should be appreciated that during the processing of a percent sign, if it is found that the percent sign needs to be retained but there is no space between the percent sign and a following word, a space may be added. For example, “100% cotton” in the above example is changed to “100% cotton.” That way, more regular information can be obtained after preprocessing.

An example of case conversion processing is as follows. The case conversion processing can be used to maintain the consistency of upper and lower cases. According to an exemplary application requirement, all upper cases may be converted into lower cases, or all lower cases may be converted into upper cases.

The title of the product is used herein as an example. After the connecting-symbol retention processing is performed, an example of the title before the case conversion processing can be as follows: SEXY style girls' black dresses package-hip-dress one shouder longSLEEVE Green flowers v-neck oneck COCKAIL DR-ESS wholesale and retail free shipping 100% cotton

After the connecting-symbol retention processing and the case conversion processing, the title can be as follows: sexy style girls' black dresses package-hip-dress one shouder longsleeve green flowers v-neck oneck cockail dr-ess wholesale-retail free shipping 100% cotton

An example of spelling consistency check processing is as follows. It may be found through analysis that the same word may be spelled differently in different positions. For example, the word “dresses” may correspond to different spellings including (the list being not exhaustive): “dresses,” “dr-esses,” and “dress-es.” Such different spellings can cause difficulty in subsequent analysis, and the quality of term extraction may be affected. Based on this, the spelling consistency check processing can be performed on the original description information in advance to convert these words having different spellings into the same spelling.

For each word or phrase in the original description information, if the word or phrase corresponds to a plurality of spellings in the original description information, the number of times that each spelling appears in the data warehouse can be counted. According to the number of times that each spelling appears in the data warehouse, a spelling of which the number of times is the largest and is greater than a preset threshold can be selected from the plurality of spellings and used as a target spelling. Other spellings of the word or phrase that appear in the original description information can be replaced with the target spelling.

For example, a total of three spellings, “dresses,” “dr-esses,” and “dress-es” of the word “dresses” may be included in the description information. By analyzing the statistics, it can be found that “dresses” is the spelling of which the number of times that the spelling appears in the data warehouse is the largest and is greater than a preset number-of-times threshold. In that case, “dresses” may be used as a target spelling, and the spellings “dr-esses” and “dress-es” can be replaced with “dresses.”

Further, spelling consistency check processing can be performed on the title after performance of the connecting-symbol retention processing and the case conversion processing. In the above example, the title can be converted into: sexy style girls' black dresses package-hip-dress one shouder longsleeve green flowers v-neck o-neck cockail dress wholesale-retail free shipping 100% cotton

An example of word segmentation processing is as follows. In some cases, a plurality of words may be written together in the original description information, for example, “longsleeve” in the above exemplary title. There may also be misspelled words, for example, “shouder” (which should be “shoulder”) and “cockail” (which should be “cocktail”) in the above exemplary title. These errors may affect subsequent processing and therefore need to be corrected.

To address the foregoing problem, a correction process can be performing word segmentation processing on the original description information. This can include recognizing existing words written together in the original description information, and segmenting the recognized words written together.
Eexamples of a result of the word segmentation processing are as follows: longsleevefloorlengthdress->long sleeve floor length dress dgdhlongsleevekl->dgdh long sleeve kl swearskirt->swear skirt

In the foregoing examples, words written together are on the left side of “->,” and a result of segmentation is shown on the right side of “->.” In the first example above, a character string to be processed includes a plurality of words. After word segmentation, the words are obtained through segmentation. In the second example above, there are several interfering characters at the front, and interfering characters at the end. After word segmentation, the words included therein (longs sleeve) are obtained, and interfering characters are also recognized. In the third example above, an optimal segmentation strategy is adopted so that the words obtained through segmentation have meanings that better conform to the context.

In view of the above, the word segmentation processing can be used to eliminate interfering characters at the front and end of the character string to identify words included therein. It can also determine an optimal segmentation strategy with reference to the context, to make the context more comprehensible.

An example of the spelling correction processing is as follows. The spelling correction can be used to change a misspelled form to a correct form. For example, “sleve” can be corrected to “sleeve.” It is appreciated that the spelling correction here can be performed for any character string (token). The character string here may be a word or may be a plurality of words. As such, through the spelling correction, not only a misspelled word can be corrected, but also a phrase that is formed of a plurality of words and including misspelling.

For example, an example of a result of spelling correction processing is as follows:

sieve->sleeve

dres->dress

wholesle->wholesale

shouder->shoulder

saikaaadffdsaf->saikaaadffdsaf

sleeve->sleeve

sleever->sleeve

sleeev->sleeve

sleeevt->sleeve

longsleve->longsleeve

In the foregoing example, the misspelled form is on the left side of “->,” and the corrected spelling form is shown on the right side of “->.”

Examples of the word segmentation processing and the spelling correction processing are described above. They may be used in combination in actual applications. Some words that are written together may also be misspelled. For example, “longsleve” in the foregoing example of the title is a misspelled form on which word segmentation may not be directly performed. The misspelled form can be corrected first. For example, “longsleve” can be corrected to “longsleeve.” After the correction, word segmentation processing can be performed on “longsleeve” to obtain a correct form “long sleeve.” Herein, by using word segmentation and spelling correction in combination, problems that cannot be resolved by using a single technique can be resolved, so that data preprocessing can be improved.

In the foregoing example, word segmentation and spelling correction can be further performed on the foregoing example of the title, after the connecting-symbol retention processing, the case conversion processing, and the spelling consistency check processing, so that the title is converted into:

sexy style girls' black dresses package-hip-dress one shoulder long sleeve green flowers v-neck o-neck cocktail dress wholesale-retail free shipping 100% cotton

As example of noun lemmatization is as follows. Noun lemmatization can refer to lemmatizing a noun in the original description information, that is, changing a plural noun to a singular noun. Considering that a gerund or a past tense verb may be adjectives and may have particular meanings, lemmatization of verbs and adjectives may not be performed in some embodiments.

In this example, lemmatization may be performed on a noun in the original description information according to at least one of a dictionary and a preset rule of singular-plural conversion.

Noun lemmatization based on a dictionary may be relatively more reliable. An example process can include: acquiring all nouns and plural forms of the nouns from the dictionary, constructing mapping relationships between the nouns and the plural forms of the noun; recognizing a plural noun in the description information based on the mapping relationship; and changing the plural noun to a singular noun.

With respect to noun lemmatization based on a preset singular-plural conversion rule, the singular-plural noun conversion rule can be set in advance. For example, changing a noun to a plural form may include adding “s” at the end, changing an end character “y” to “ies,” and the like. A plural noun in the description information can be recognized based on the conversion rule. Reverse processing can be performed on the recognized plural noun according to the conversion rule to change the plural noun back to a singular noun.

In actual applications, noun lemmatization processing may be first performed based on a dictionary. If a noun cannot be changed back to a singular noun based on the dictionary, noun lemmatization processing can further be performed based on a singular-plural conversion rule. Generally, the dictionary may have relatively higher accuracy, whereas the rule may have relatively wider coverage. If the dictionary and the conversion rule are used in combination, the accuracy of noun lemmatization can be improved. Further, a combination of both can also help ensure more nouns can be recognized and changed from plural nouns back to singular nouns.

In the foregoing example, noun lemmatization can be further performed on the title after the connecting-symbol retention processing, the case conversion processing, the spelling consistency check processing, the word segmentation, and the spelling correction. The title can then be converted into:

sexy style girls' black dress package-hip-dress one shoulder long sleeve green flower v-neck o-neck cocktail dress wholesale-retail free shipping 100% cotton

It is appreciated that in the above description, different preprocessing techniques are separately described above. In actual applications, different preprocessing techniques may be separately used or may be used in combination. After preprocessing, the original description information becomes more regular. The acquired description information after preprocessing can be used for subsequent term extraction, as further described below.

In some embodiments, to achieve more comprehensive term extraction, a term extraction apparatus can perform term extraction through two procedures. The term extraction apparatus can perform an explicit-term extraction procedure on the description information to extract explicit terms from the description information. Further, the term extraction apparatus can perform a mode-term extraction procedure on the description information to extract implicit terms from the description information.

An explicit term can refer to a term that can be easily discovered, and an implicit term can refer to a term that cannot be easily discovered. The term extraction apparatus can extract both explicit terms and implicit terms. Therefore, more comprehensive term extraction can be achieved. In addition, the term extraction apparatus performs term extraction based on massive description information, without depending on manual labor. Therefore, errors that occur in manual work can be avoided, and the extraction quality can be ensured. It should be appreciated that an order of performing the operation of extracting an explicit term and the operation of extracting an implicit term is not limited by the embodiments disclosed herein. The operations may be performed in either order or may be performed concurrently.

In some embodiments, the explicit-term extraction procedure can include loading a preset explicit term rule, and extracting an explicit term from the description information according to the explicit term rule. Based on this, an implementation manner of performing an explicit-term extraction procedure on the description information to extract an explicit term from the description information can include: loading a preset explicit term rule; extracting an information segment that conforms to the explicit term rule from the description information; and using the information segment as the explicit term.

In some embodiments, the explicit term rule can include, but is not limited to, at least one of a designated character-string condition rule, a field dictionary rule, and an attribute value rule. The designated character-string condition rule can be used to indicate that a character string that conforms to a designated character-string condition can be used as an explicit term. The field dictionary rule can be used to indicate that a term that is in a field dictionary can be used as an explicit term. Field dictionaries can be different and may correspond to different fields. For example, in the garment field, the English-Chinese Textiles Dictionary can be used as a field dictionary. The attribute value rule can be used to indicate that an attribute value in the attribute information of the network resource can be used as an explicit term.

Based on the foregoing, extracting an information segment that conforms to the explicit term rule from the description information and using the information segment as the explicit term may include at least one of the following: extracting a character string that conforms to a designated character-string condition from the description information and using the character string as the explicit term; extracting a term that is in a field dictionary from the description information and using the term as the explicit term; and extracting, when the description information includes attribute information of the network resource, an attribute value in the attribute information, and using the attribute value as the explicit term.

Exemplary processing of extracting a character string that conforms to a designated character-string condition and using the character string as the explicit term is further described below. There can be a character string connected by a hyphen “-” in the description information of the network resource. For example, “package-hip-dress,” “v-neck,” “o-neck,” “wholesale-retail,” “one-shoulder,” “long-sleeve,” and the like are all character strings connected by a hyphen “-.” A character string connected by a hyphen “-” can be formed by connecting a plurality of words together and can be used to express a richer semantic meaning. Therefore, a probability that a character string connected by a hyphen “-” is a term is relatively high. It is appreciated that some character strings connected by a hyphen “-” may have no actual meaning and therefore cannot be used as a term. For example, “a-b,” “v-neck-half-sleeve-dress,” and the like may not be used as a term.

Based on the foregoing, some conditions may be set to define a character string that is connected by a hyphen “-” that can be used as a term. These defining conditions can be referred to as character-string conditions. Such conditions can include at least one condition in the following:

The character string is connected by a hyphen “-.” This condition can be used to define that the character string is connected by a hyphen “-” to be considered as a term. The character string connected by a hyphen “-” may be referred to as a token.

The number of times that the character string appears is greater than a preset number-of-times threshold. This condition may require that the number of times that the character string appears should be greater than the preset number-of-times threshold, for example, greater than 500. The number of times that the character string appears here can refer to the number of times that the character string appears in the data warehouse.

The character string is not an English word. This condition can be used to eliminate words, that is, a word is not considered a term.

The last word of the character string does not end with “s,” “es,” “ex,” “ed,” “d,” “ing,” “ings,” “ry,” “ies,” “ves,” “y” or “a.” This condition can be used to avoid a term including a plural noun, a past tense verb, present progressive tense, or the like.

The character string does not include a conjunction. This condition can be used to avoid a term including a conjunction, such as “and,” “but,” “or,” “for,” “so,” and “nor.”

The character string does not include a stop word. This condition can be used to avoid that a stop word, such as “of” and “a,” appears in a term.

The character string includes a designated number of words. This condition can be used to indicate that the character string includes the designated number of words to be a term. If the character string does not include the designated number of words, the character string cannot be a term.

The character string does not include a number (except a percentage). This condition can be used to indicate that a character string that includes a number cannot be a term.

The length of a word in the character string is less than a designated length for example, less than 20 letters. This condition can be used to indicate that the length of a word in the character string is less than a designated length for the character string to be a term. If the character string is longer than the designated length, the character string cannot be a term.

The length of the character string is greater than the number of words included in the character string. This condition can indicate that the length of the character string is greater than the number of words included in the character string for the character string to be a term. If the length of the character string is not greater than the number of words included in the character string, the character string cannot be a term.

The character string does not conform to a designated regular rule. This condition can indicate that a character string that does not conform to the designated regular rule can be a term. In contrast, a character string that conforms to the regular rule cannot be a term. For example, the regular rule here can include, but is not limited to, “as−\w+,” which represents a character string that begins with “as−,” and “so−\w+,” which represents a character string that begins with “so−.”

Based on the foregoing character-string conditions, which character strings are explicit terms and which character strings are not explicit terms can be determined. For example, it can be determined that the following character strings are not terms:
sleeve-less: the last word ends with “s;”
dress-es: the last word ends with “s” or
sleeve-s: the last word ends with “s;”
full-sleevevneckdresssexyclubwear: the length of a word in the character string exceeds a designated length;
a-b: the length of the character string is not greater than the quantity of words included in the character string;
half-3sleeve: the character string includes a number 3;
v-neck-half-sleeve-dress: the character string includes too many words;
fashion-ladies-blue-dress-party: the character string includes too many words;
as-picture: the character string conforms to a designated regular rule; and
so-good: the character string conforms to a designated regular rule.

Similarly, it can be determined that the following character strings are terms: v-neck, deep-v-neck, green-flower, floor-length, 100%-silk.

The description information of the network resource may include, but is not limited to, the title, the attribute information, and the keywords of the network resource. In light of this, during the implementation of extracting a character string that conforms to a designated character-string condition and using the character string as the explicit term, the title, the attribute information, the keywords, and the like of the network resource may be combined into one information set. A character string that conforms to a designated character-string condition can be extracted from the information set and used as the explicit term.

Alternatively, the implementation of extracting a character string that conforms to a designated character-string condition and using the character string as the explicit term can include the following: a character string that conforms to a designated character-string condition may be separately extracted from the title of the network resource and used as the explicit term, a character string that conforms to a designated character-string condition may be separately extracted from the attribute information of the network resource and used as the explicit term, a character string that conforms to a designated character-string condition may be separately extracted from the keywords of the network resource and used as the explicit term, and the like.

A network resource may have a plurality of attributes. However, not all the attributes are equally useful for term extraction. Based on this, a screening rule may be configured in advance according to the application scenario and used to screen all the attributes to obtain attributes that are useful for term extraction. The obtained attributes can be referred to as critical attributes. The critical attributes can be used as a corpus to perform term extraction.

The field of electronic commerce is used here as an example. The network resource can be a product. A user can configure a screening rule in advance, and select critical attributes by using the screening rule. Different resource categories may correspond to different screening rules, and different critical attributes can be obtained through screening. It is assumed that a category with an ID “3” is “Apparel,” as shown below in Table 1. Critical attributes that are obtained through screening according to a preset screening rule can include, but are not limited to, those as shown below in Table 1.

TABLE 1

| Category name | Category ID | Name of Critical Attribute |
|---|---|---|
| Apparel | 3 | Length |
| Apparel | 3 | Decoration |
| Apparel | 3 | Sleeve Style |
| Apparel | 3 | Neckline |
| Apparel | 3 | Gender |

Example processes of extracting a term that is in a field dictionary and using the term as the explicit term are further described below in detail. The field dictionary stores terms in a corresponding field. Therefore, it can be directly determined whether the description information includes a term that is included in the field dictionary. If the term is included in the field dictionary, the term can be directly determined as an explicit term. The above process involves relatively simple implementation and has relatively high efficiency. It can be used to identify relatively obvious terms.

Example processes of extracting an attribute value in the attribute information and using the attribute value as the explicit term are further described below. The attribute information can include an attribute name and an attribute value. An exemplary structure of the attribute information can be “attribute name: attribute value.” With such a structure, the attribute value is usually a phrase having a clear meaning. Therefore, the attribute information may be directly identified from the description information, and the attribute value in the attribute information can be extracted and used as the explicit term.

As described above, the explicit term may be extracted in various manners. It is appreciated that the several manners of extracting the explicit term described herein may be used separately or may be used in any combination thereof.

In some embodiments, the mode-term extraction procedure can include loading a preset mode combination rule and extracting an implicit term from the description information according to the mode combination rule. Based on this, an exemplary process of performing the mode-term extraction procedure on the description information to extract an implicit term from the description information can include: loading a preset mode combination rule; extracting an information segment that conforms to the mode combination rule from the description information; and using the information segment as the implicit term.

In some embodiments, the mode combination rule can include, but is not limited to, at least one of a part-of-speech combination rule, a regular expression rule, and an attribute expression rule. The part-of-speech combination rule can be used to indicate that a word combination that conforms to a designated part-of-speech combination condition may be used as the implicit term. The regular expression rule can be used to indicate that a word combination that conforms to a designated regular expression may be used as the implicit term. The attribute expression rule can be used to indicate generating the implicit term based on a preset generation rule and according to the attribute information.

Based on the above described mode combination rules, extracting an information segment that conforms to the mode combination rule from the description information and using the information segment as the implicit term can include at least one operation in the following: extracting a word combination that conforms to a designated part-of-speech combination condition from the description information and using the word combination as the implicit term; extracting a word combination that conforms to a designated regular expression from the description information and using the word combination as the implicit term; and generating, when the description information includes attribute information of the network resource, the implicit term based on a preset generation rule and according to the attribute information.

Example processes of extracting a word combination that conforms to a designated part-of-speech combination condition from the description information and using the word combination as the implicit term are described below. In some embodiments, research and analysis shows that some part-of-speech combination modes are generally terms. For example, word combinations such as “adjective+noun” (“̂JJ\\s+NNS{0,1}$”) and “adjective+adjective+noun” (“̂JJ\\s+JJ\\s+NNS{0,1}$”) are usually terms. In light of this, the part-of-speech combination condition may include, for example, an “adjective+noun” mode and an “adjective+adjective+noun” mode. It is appreciated that in addition to the above two part-of-speech combination modes, there can be other part-of-speech combination modes. Based on the above, “green flowers,” “natural-color,” “hooded-collar,” and the like are word combinations in the “adjective+noun” mode and are terms. As another example, “small green flowers” and the like are word combinations in the “adjective+adjective+noun” mode and are also terms.

In actual implementation, the term extraction apparatus may set a window length according to the number of words included in a term. The apparatus can sequentially sample the description information according to the set window length and determine whether a sampled word combination conforms to the part-of-speech combination condition. If the sampled word combination conforms to the part-of-speech combination condition, the term extraction apparatus can determine that the word combination is an implicit term. If the sampled word combination does not conform to the part-of-speech combination condition, the term extraction apparatus can discard the word combination and continues to perform the next sampling. For example, it may be set that a term includes two or three words. In that case, two window lengths, namely, 2 and 3, may be set and used to sample a word combination whose length is 2 or 3.

Examples of the foregoing solution of extracting a word combination that conforms to a designated regular expression from the description information and using the word combination as the implicit term are further described below. In some embodiments, some terms are not fixed collocations and may not conform to the part-of-speech combination mode. That is, such terms cannot be obtained based on normal grammar rules. However, these terms may conform to a particular word formation manner. For example, there are terms that end with “style,” or terms that begin with a percentage, and the like. For these terms, a regular expression can be preset, and a word combination that conforms to the preset regular expression can be determined to be a term.

Below are some exemplary regular expressions representing certain terms:
“̂[a-z]?\\s+style$” represents an “xxx” style. That is, a word combination in a “word+style” form may be a term and needs to be acquired, such as “sexy style” or “bohemia style.”
“[0-9]+%\\s+[a-z]+$” represents “xx % xxx.” That is, a word combination in a “percentage+word” form may be a term and needs to be acquired, such as “100% cotton.”

In some embodiments, the term extraction apparatus may search the description information according to an identifier part (for example, “style” and “%”) in a regular expression. After recognizing the identifier part, the term extraction apparatus can determine, according to a format of the regular expression, whether a word before or after the identifier part conforms to a requirement of the regular expression. If a word before or after the identifier part conforms to a requirement of the regular expression, the term extraction apparatus can acquire a word combination that includes the identifier part and the word before or after the identifier part and use the word combination as the implicit term.

Examples of the foregoing solution of generating the implicit term based on a preset generation rule and according to the attribute information are described below. In some embodiments, the attribute information of the network resource can include an attribute name and an attribute value. When the description information includes attribute information of the network resource, the implicit term may be generated based on the preset generation rule and according to the attribute information. For example, the generation rule can be used to instruct a term extraction apparatus to convert an attribute name into a display attribute name, and combine an attribute value with the display attribute name to generate the implicit term.

Based on the foregoing, in some embodiments, generating the implicit term based on a preset generation rule and according to the attribute information can include: generating a display attribute name according to an attribute name in the attribute information, and combining an attribute value in the attribute information with the display attribute name to generate the implicit term. A conversion rule between an attribute name and a display attribute name may be preset. The display attribute name can be generated based on the conversion rule. The conversion rule may be adaptively set according to different application scenarios. Taking a garment category in the field of electronic commerce as an example, exemplary conversion rules between an attribute name and a display attribute name can be as follows:

dresses length/dress

sleeve length/sleeve

sleeve style/sleeve

sleeve type/sleeve

sleeve/sleeve

hooded/hooded

material/NULL

neckline/neckline

waistline/waistline

decoration/decoration

style/style

silhouette/silhouette

fabric type/fabric

season/NULL

for season/NULL

for the season/NULL

pattern type/pattern

color/NULL

color style/NULL

techniques/techniques

item type/NULL

item name/NULL

product category/NULL

outerwear type/outerwear

eyewear type/NULL

scarves type/NULL

clothing length/clothing

collar/collar

closure type/closure

thickness/thickness

back design/back

built-in bra/built-in bra

waistline/waistline

wedding dress fabric/NULL

In the foregoing examples, each example includes three parts: an attribute name, a slash, and a display attribute name. The slash is used to separate the attribute name and the presented attribute name. The attribute name is on the left side of the slash, and the display attribute name is on the right side of the slash.

Based on the foregoing example, one implementation manner of generating the implicit term can be “attribute value+display attribute name.” The term extraction apparatus may acquire the attribute information, and convert the attribute name in the attribute information into the display attribute name according to the conversion rule. The term extraction apparatus can then combine the attribute value with the display attribute name in the foregoing manner to form the implicit term. For example, a piece of attribute information is “sleeve length: half,” wherein the attribute name is “sleeve length,” and the attribute value is “half.” The attribute name “sleeve length” may be converted into the display attribute name “sleeve.” The attribute value “half” and the display attribute name “sleeve” are combined to generate the implicit term “half-sleeve.”

As another example, a piece of attribute information is “sleeve style: bat wing,” wherein the attribute name is “sleeve style,” and the attribute value is “bat wing.” The attribute name “sleeve style” may be converted into the display attribute name “sleeve.” The attribute value “bat wing” and the display attribute name “sleeve” are combined to generate the implicit term “bat-wing-sleeve.” It should be noted that in the foregoing examples, the display attribute name may be “NULL.” That means, when the implicit term is generated, the display attribute name is null, and the attribute name is not used.

In addition, some attribute values may be Boolean type data. For example, the attribute information is “build-in-bra: yes,” which can be used for products in a wedding dress category to indicate whether a bra is built in a wedding dress. If the attribute value is “yes” or “y” and the like, it indicates “yes,” and the attribute value may be omitted during formation of the implicit term. If the attribute value does not indicate “yes,” the attribute value may be retained and not omitted. For example, according to the attribute information “build-in-bra: yes,” the formed implicit term can be “build-in-bra.” As another example, according to the attribute information “build-in-bra: not,” the formed implicit term can be “not-build-in-bra.”

In view of the foregoing, the implicit terms may be extracted from the description information after the operations described above. It is appreciated that the different manners of extracting implicit terms in the foregoing may be used separately, or may be used in any combination.

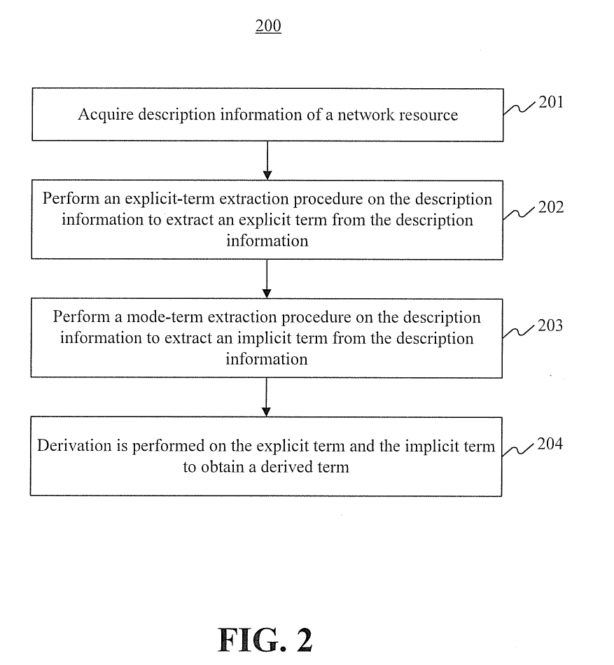

FIG. 2 is a schematic flowchart of an exemplary term extraction method 200 according to some embodiments of the present disclosure. As shown in FIG. 2, the exemplary method 200 includes steps 201-204. Processing in steps 201-203 is similar to the processing described above with reference to FIG. 1, details of which is not repeated herein. After the explicit term and the implicit term are extracted in step 203, the method can further include the following procedures.

In step 204, derivation is performed on the explicit term and the implicit term to obtain a derived term. In some embodiments, implementation of step 204 can include: determine an Inverse Document Frequency (IDF) value of a noun in the explicit term or the implicit term; if the IDF value is lower than a preset threshold, deleting the noun from the explicit term or the implicit term to obtain a term segment; and determining whether the term segment conforms to a term condition. If the term segment conforms to the term condition, determining the term segment as the derived term. If the term segment does not conform to the term condition, discarding the term segment.

It is appreciated that the term condition can be used to determine whether one term segment is a term. In actual implementation, the term condition may include, but is not limited to, the above-described explicit term rule (for example, a character-string condition, a field dictionary rule, and a rule of extracting an attribute value), and the mode combination rule (for example, a part-of-speech combination condition, a regular expression, and a generation rule), and the like. That is, if a remaining term segment obtained after the noun whose IDF value is lower than the preset threshold is removed conforms to the character-string condition, the field dictionary, the rule of extracting an attribute value, the part-of-speech combination condition, the regular expression, or the generation rule, the term segment can be determined as a term.

For example, the extracted explicit terms and the implicit terms include: “half-sleeve-dress,” “package-hip-dress,” and “full-sleeve-dress.” It is found through statistical analysis that an IDF value of the noun “dress” is lower than a threshold. This noun is then removed from corresponding terms to obtain term segments: “half-sleeve,” “package-hip,” and “full-sleeve.” It can be determined, based on term extraction analysis as described above, that the three term segments all conform to the term condition. In this case, the term segments “half-sleeve,” “package-hip,” and “full-sleeve” can all be determined as derived terms. Therefore, the terms now include: “half-sleeve-dress,” “package-hip-dress,” “full-sleeve-dress,” “half-sleeve,” “package-hip,” and “full-sleeve.”

In this example, the term extraction apparatus performs derivation on the explicit term and the implicit term that are extracted previously, so that new terms (that is, derived terms) may further be extracted to enrich or supplement the extracted terms and make the extracted terms more comprehensive.

In some embodiments, after the explicit term, the implicit term, and the derived term are extracted, a correction operation may further be performed on the extracted terms to facilitate removal of bad cases terms. That way, the quality and usability of the extracted terms can be improved. For example, the explicit term, the implicit term, and the derived term may be combined to form a term set, and at least one of the following correction operations can be performed on the term set: noun lemmatization, stop word removal, and low-frequency cognate removal.

The process of noun lemmatization can include: determining a term in the term set that includes a plural noun and changing the plural noun in the term back to a singular noun. For example, “sexy-style-dresses” can be changed to “sexy-style-dress.”

The process of stop word removal can include: determining a term in the term set that includes a stop word; and replacing, if a remaining part obtained after the stop word is removed from the term conforms to a term condition, the term with the remaining part. For details about the term condition, reference can be made to corresponding descriptions provided above. The stop word can include a stop word included in a stop word table corresponding to a certain field. Stop words included in a stop word table are generally standard stop words. For example, standard stop words in English include those in the following list. In some embodiments, considering that some standard stop words may be commonly shared in different fields, such as “with,” “between,” “under,” and “over,” such standard stop words may be removed from the stop word table.

For example, standard stop words in English include the following words: [u‘i’, u‘me’, u‘my’, u‘myself’, u‘we’, u‘our’, u‘ours’, u‘ourselves’, u‘you’, u‘your’, u‘yours’, u‘yourself’, u‘yourselves’, u‘he’, u‘him’, u‘his’, u‘himself’, u‘she’, u‘her’, u‘hers’, u‘herself’, u‘it’, u‘its’, u‘itself’, u‘they’, u‘them’, u‘their’, u‘theirs’, u‘themselves’, u‘what’, u‘which’, u‘who’, u‘whom’, u‘this’, u‘that’, u‘these’, u‘those’, u‘am’, u‘is’, u‘are’, u‘was’, u‘were’, u‘be’, u‘been’, u‘being’, u‘have’, u‘has’, u‘had’, u‘having’, u‘do’, u‘does’, u‘doing’, u‘a’, u‘an’, u‘the’, u‘and’, u‘but’, u‘if’, u‘or’, u‘because’, u‘as’, u‘until’, u‘while’, u‘of’, u‘at’, u‘by’, u‘for’, u‘with’, u‘about’, u‘against’, u‘between’, u‘into’, u‘through’, u‘during’, u‘before’, u‘after’, u‘above’, u‘below’, u‘to’, u‘from’, u‘up’, u‘down’, u‘in’, u‘out’, u‘on’, u‘off’, u‘over’, u‘under’, u‘again’, u‘further’, u‘then’, u‘once’, u‘here’, u‘there’, u‘when’, u‘where’, u‘why’, u‘how’, u‘all’, u‘any’, u‘both’, u‘each’, u‘few’, u‘more’, u‘most’, u‘other’, u‘some’, u‘such’, u‘no’, u‘nor’, u‘not’, u‘only’, u‘own’, u‘same’, u‘so’, u‘than’, u‘too’, u‘very’, u‘s’, u‘t’, u‘can’, u‘will’, u‘just’, u‘don’, u‘should’, u‘now’]

In some embodiments, the stop word table may further include a term that contributes little, which may be referred to as a useless term. For example, “wholesale,” “retail,” “shipping,” “free-shipping,” “fashion,” “price,” “offer,” “none,” “quantity,” “shipment,” and the like, can be considered useless terms in the field of electronic commerce.

The process of low-frequency cognate removal can include: determining cognate terms in the term set and deleting a term in the cognate terms based on a designated word frequency condition. The cognate terms can include terms whose first n words are the same, n being a natural number greater than or equal to 2. For example, terms whose first two words are the same may be determined as cognate terms. For example, “half-sleeve-dress,” “half-sleeve-shirt,” “half-sleeve-long,” and “half-sleeve” can be determined as cognate terms. In an exemplary scenario, the word frequency of “half-sleeve-dress” is 1000, the word frequency of “half-sleeve-shirt” is 900, the word frequency of “half-sleeve-long” is 10, and the word frequency of “half-sleeve” is 1100. Meanwhile, the designated word frequency condition is that the word frequency of a term is less than the word frequency of a cognate term by more than 30%. Based on this condition, it can be determined that “half-sleeve-long” conforms to the designated word frequency condition. That is, the word frequency 10 of “half-sleeve-long” is less than the word frequency 1100 of “half-sleeve” by more than 30%. Therefore, “half-sleeve-long” can be removed.

As can be seen from above, in some embodiments of the present disclosure, description information of a network resource can be used as a corpus used for term extraction. An explicit-term extraction procedure and a mode-term extraction procedure can be first performed on the description information. Explicit terms that can be easily discovered and implicit terms that may not be easily discovered can both be extracted from the description information. More comprehensive term extraction can be achieved, and term extraction quality can be ensured. Further, derivation can be performed on the extracted explicit terms and implicit terms to obtain derived terms, to further extract new terms (that is, derived terms). That way, extracted terms can be enriched and supplemented, and the extracted terms can be more comprehensive. Furthermore, in the present disclosure, a correction operation can be performed on the extracted terms, so that the terms are changed to regular forms. Bad case terms can be removed. That way, quality of the extracted terms can be improved, as well as their usability.

The foregoing exemplary method embodiments may have been described as a series of action combinations. It is appreciated that the present disclosure is not limited to the described orders or actions. Consistent with the present disclosure, in some other embodiments, some steps may be performed in another order or be performed simultaneously. It should be appreciated that the embodiments described herein are only exemplary. The actions and modules described above may not be mandatory in every embodiments of the present disclosure. Further, in the above exemplary embodiments, the descriptions of the various embodiments may focus on different aspects of the technical solutions. For parts that are not described in detail in a certain embodiment, references can be made to related descriptions in other embodiments.

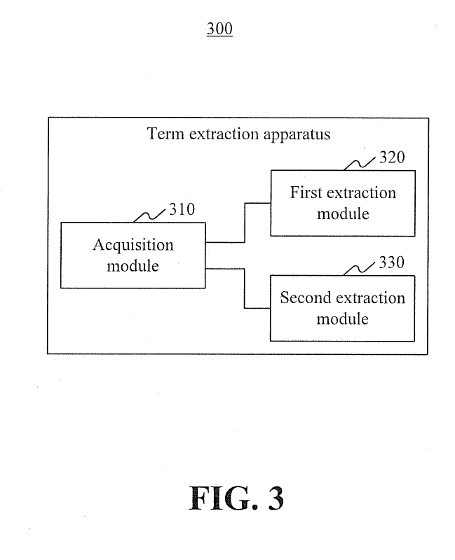

FIG. 3 is a schematic structural diagram of an exemplary term extraction apparatus 300 according to some embodiments of the present disclosure. As shown in FIG. 3, the apparatus includes: an acquisition module 310, a first extraction module 320, and a second extraction module 330.

Acquisition module 310 can be configured to acquire description information of a network resource. First extraction module 320 is configured to perform an explicit-term extraction procedure on the description information to extract an explicit term from the description information. Second extraction module 330 can be configured to perform a mode-term extraction procedure on the description information to extract an implicit term from the description information.

It should be appreciated that for ease of description, in terms of modular division, extraction modules in this example include first extraction module 320 and second extraction module 330. Other embodiments may have a different structure of modules. For example, first extraction module 320 and second extraction module 330 may be combined into one extraction module in some embodiments. In addition, the order of extraction operations performed by first extraction module 320 and second extraction module 330 is not limited by the embodiments described herein.

In some embodiments, first extraction module 320 can further be configured to: load a preset explicit term rule; and extract an information segment that conforms to the explicit term rule from the description information and use the information segment as the explicit term. Further, the explicit term rule can include, but is not limited to, at least one of a designated character-string condition rule, a field dictionary rule, and an attribute value rule. The designated character-string condition rule can be used to indicate that a character string that conforms to a designated character-string condition can be used as the explicit term. The field dictionary rule can be used to indicate that a term that is included in a field dictionary can be used as the explicit term. Field dictionaries may be different and may correspond to different fields. For example, in the garment field, the English-Chinese Textiles Dictionary may be used as a field dictionary. The attribute value rule can be used to indicate an attribute value in the attribute information of the network resource can be used as the explicit term.

Based on the foregoing explicit term rules, first extraction module 320 can be configured to perform at least one of the following operations: extracting a character string that conforms to a designated character-string condition from the description information and using the character string as the explicit term; extracting a term that is included in a field dictionary from the description information and using the term as the explicit term; and extracting, when the description information includes attribute information of the network resource, an attribute value in the attribute information, and using the attribute value as the explicit term.

In some embodiments, the designated character-string condition can include at least one condition in the following: the character string is connected by a hyphen “-;” the number of times that the character string appears is greater than a preset number-of-times threshold; the character string is not an English word; the last word of the character string does not end with “s,” “es,” “ex,” “ed,” “d,” “ing,” “ings” “ry,” “ies,” “ves,” “y” or “a;” the character string does not include a conjunction; the character string does not include a stop word; the character string includes a designated number of words; the character string does not include a number; the length of a word in the character string is less than a designated length; the length of the character string is greater than the number of words included in the character string; and the character string does not conform to a designated regular rule.

In some embodiments, second extraction module 330 can be configured to: load a preset mode combination rule; and extract an information segment that conforms to the mode combination rule from the description information and use the information segment as the implicit term. The mode combination rule can include, but is not limited to, at least one of a part-of-speech combination rule, a regular expression rule, and an attribute expression rule. The part-of-speech combination rule can be used to indicate that a word combination that conforms to a designated part-of-speech combination condition can be used as the implicit term. The regular expression rule can be used to indicate that a word combination that conforms to a designated regular expression can be used as the implicit term. The attribute expression rule can be used to indicate generating the implicit term based on a preset generation rule and according to the attribute information.

Based on the foregoing, second extraction module 330 can further be configured to perform at least one operation in the following: extracting a word combination that conforms to the designated part-of-speech combination condition from the description information and using the word combination as the implicit term; extracting a word combination that conforms to a designated regular expression from the description information and using the word combination as the implicit term; and generating, when the description information includes attribute information of the network resource, the implicit term based on a preset generation rule and according to the attribute information.

In some embodiments, when generating the implicit term based on the preset generation rule and according to the attribute information, second extraction module 330 can be further configured to: generate a display attribute name according to an attribute name in the attribute information and combine an attribute value in the attribute information with the display attribute name to generate the implicit term.

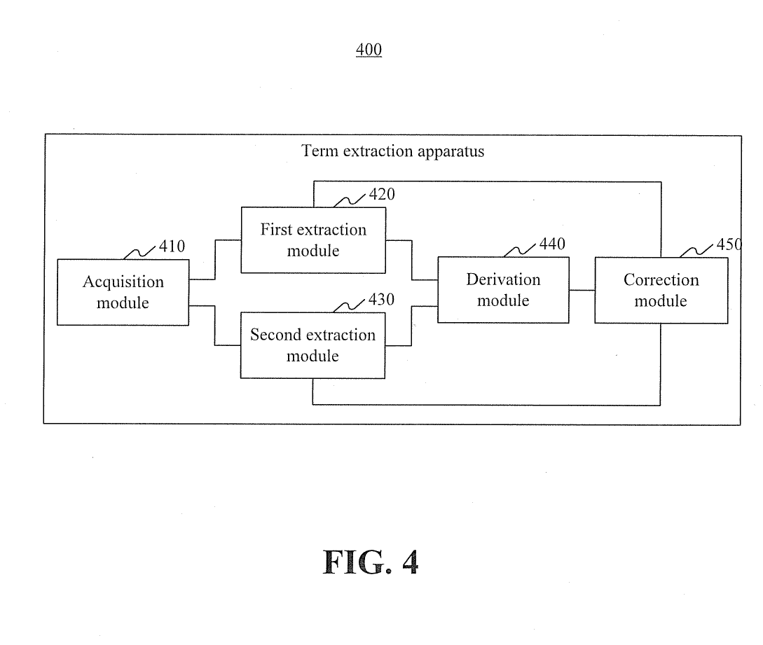

FIG. 4 is a schematic structural diagram of an exemplary term extraction apparatus 400 according to some embodiments of the present disclosure. As shown in FIG. 4, the exemplary apparatus 400 includes: an acquisition module 410, a first extraction module 420, a second extraction module 430, a derivation module 440, and a correction module 450. Acquisition module 410, first extraction module 420, and second extraction module 430 can perform processing similar to those described above with respect to FIG. 3 and the corresponding steps in the above-described method embodiments, the details of which are not repeated herein.

Derivation module 440 can be configured to perform derivation on the explicit term and the implicit term to obtain a derived term. For example, derivation module 440 can be configured to: determine an Inverse Document Frequency (IDF) value of a noun in the explicit term or the implicit term; if the IDF value is lower than a preset threshold, delete the noun from the explicit term or the implicit term to obtain a term segment; and determine the term segment as the derived term if the term segment conforms to a term condition.

Correction module 450 can be configured to combine the explicit term, the implicit term, and the derived term to form a term set, and perform at least one correction operation in the following on the term set: determining a term in the term set that includes a plural noun, and changing the plural noun in the term back to a singular noun; determining a term in the term set that includes a stop word, and replacing, if a remaining part obtained after the stop word is removed from the term conforms to a term condition, the term with the remaining part; and determining cognate terms in the term set, and deleting a term in the cognate terms that does not conform to a designated word frequency condition, the cognate terms including terms whose first n words are the same, n being a natural number greater than or equal to 2.

According to the above term extraction apparatuses provided in this present disclosure, description information of a network resource can be used as a corpus for term extraction. An explicit-term extraction procedure and a mode-term extraction procedure are performed on the description information. Explicit terms that can be easily discovered and implicit terms that may not be easily discovered can both be extracted from the description information. Therefore, more comprehensive term extraction can be achieved, and term quality can be ensured. Further, in some embodiments, derivation is performed on the extracted explicit terms and implicit terms to obtain derived terms to further extract new terms (that is, derived terms). That way, extracted terms can be enriched and supplemented, and the extracted terms can be more comprehensive. Furthermore, in some embodiments, a correction operation is performed on the extracted terms, so that the terms can be changed to regular forms. Bad case terms can be removed. Term quality can be ensured, as well as their usability.

It is appreciated that, for a detailed description of the working processes of the foregoing apparatuses, and units, reference can be made to the corresponding description in the foregoing method embodiments, the details of which are not repeated herein. In the several embodiments provided in the present disclosure, it should be appreciated that the disclosed apparatuses, and methods can also be implemented in other manners. The described embodiments are only exemplary. For example, in the above described apparatus embodiments, the unit division only represents a merely logical function division, and other division manners may be adopted in actual implementation. Further, a plurality of units or components may be combined or integrated into another system or unit. Some features or processes may be omitted or not performed in some embodiments. In addition, the shown or discussed mutual couplings or direct couplings or communication connections may be implemented through various interfaces. The indirect couplings or communication connections between the apparatuses or units may be implemented in electrical, mechanical, or other forms.

The units described above as separate parts may or may not be physically separate, and parts shown as units may or may not be in the form of physical units. The units may be located in one position or may be distributed on a plurality of network units. A part or all of the units may be selected or adjusted according to actual needs to achieve the objectives of the technical solutions of the embodiments. In addition, functional units in the above-described embodiments of the present disclosure may be integrated into one processing unit, or each of the units may exist alone physically, or two or more units are integrated into one unit. The integrated unit may be implemented in the form of hardware, or a software functional unit combined with hardware.

When the foregoing integrated units are implemented in a form of a software functional unit, the integrated units may be stored in a computer-readable storage medium. The software functional unit can be stored in a storage medium and includes several instructions for instructing a computer device or a processor to perform some or all of the steps of the method embodiments of the present disclosure. The computer device may be a personal computer, a server, or a network device. The foregoing storage medium can include any medium that can store program codes, such as a USB flash drive, a mobile hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

It is appreciated that the foregoing embodiments are merely intended for describing some exemplary technical solutions of the present disclosure. They do not limit the scope of the present disclosure. Consistent with the present disclosure, those of ordinary skill in the art can make modifications to the technical solutions described in the foregoing embodiments, or make equivalent replacements to some technical features thereof. These modifications or replacements, without departing from the spirit and scope of the present disclosure, shall all fall within the scope of the present disclosure.

1. A term extraction method, comprising:
acquiring description information of a network resource;
performing an explicit-term extraction procedure on the description information to extract an explicit term from the description information; and
performing a mode-term extraction procedure on the description information to extract an implicit term from the description information.

2. The method according to claim 1, wherein acquiring description information of a network resource comprises:
preprocessing original description information of the network resource.

3. The method according to claim 2, wherein preprocessing the original description information comprises performing at least one of the following on the original description information: connecting-symbol retention processing, case conversion processing, spelling consistency check processing, word segmentation processing, spelling correction processing, or noun lemmatization processing.

4. The method according to claim 1, wherein performing the explicit-term extraction procedure on the description information to extract the explicit term from the description information comprises:
loading a preset explicit term rule; and
extracting an information segment based on the explicit term rule from the description information and using the information segment as the explicit term.

5. The method according to claim 4, wherein extracting the information segment based on the explicit term rule comprises at least one of:
extracting, from the description information, a character string that conforms to a designated character-string condition;
extracting, from the description information, a term that is included in a field dictionary; or
extracting, from the description information, an attribute value included in attribute information.

6. The method according to claim 5, wherein the designated character-string condition comprises at least one of:
the character string is connected by a hyphen “-;”
the number of times that the character string appears is greater than a preset number-of-times threshold;
the character string is not an English word;
the last word of the character string does not end with “s,” “es,” “ex,” “ed,” “d,” “ing,” “ings” “ry,” “ies,” “ves,” “y” or “a;”
the character string does not include a conjunction;
the character string does not include a stop word;
the character string includes a designated number of words;
the character string does not include a number;
the length of a word in the character string is less than a designated length;
the length of the character string is greater than the number of words included in the character string; or
the character string does not conform to a designated regular rule.

7. The method according to claim 1, wherein performing the mode-term extraction procedure on the description information to extract the implicit term from the description information comprises:
loading a preset mode combination rule; and
extracting an information segment based on the mode combination rule from the description information and using the information segment as the implicit term.

8. The method according to claim 7, wherein extracting an information segment based on the mode combination rule from comprises at least one of:
extracting, from the description information, a word combination that conforms to a designated part-of-speech combination condition;
extracting, from the description information, a word combination that conforms to a designated regular expression; or
generating the implicit term based on a preset generation rule and according to attribute information included in the description information.

9. The method according to claim 8, wherein generating the implicit term based on the preset generation rule and according to the attribute information comprises:
generating a display attribute name according to an attribute name in the attribute information; and
combining an attribute value in the attribute information with the display attribute name to generate the implicit term.

10. The method according to claim 1, further comprising:
performing derivation on the explicit term and the implicit term to obtain a derived term.

11. The method according to claim 10, wherein performing derivation on the explicit term and the implicit term to obtain the derived term comprises:
determining an Inverse Document Frequency (IDF) value of a noun in the explicit term or the implicit term; and
in response to the IDF value being lower than a preset threshold, deleting the noun from the explicit term or the implicit term to obtain a term segment; and
determining the term segment as the derived term if the term segment conforms to a term condition.

12. The method according to claim 10, further comprising:
combining the explicit term, the implicit term, and the derived term to form a term set; and
performing at least one of the following on the term set:
determining that a term in the term set includes a plural noun, and changing the plural noun to a singular noun;
determining that a term in the term set includes a stop word, and replacing, in response to a remaining part obtained after the stop word is removed from the term confirming to a term condition, the term with the remaining part; or
determining cognate terms in the term set and deleting a term in the cognate terms that does not conform to a designated word frequency condition, wherein the cognate terms include terms whose first n words are the same, n being a natural number greater than or equal to 2.

13. A term extraction apparatus, comprising:
a memory storing a set of instructions; and
a processor configured to execute the set of instructions to cause the apparatus to perform:
acquiring description information of a network resource;
performing an explicit-term extraction procedure on the description information to extract an explicit term from the description information; and
performing a mode-term extraction procedure on the description information to extract an implicit term from the description information.

14. The apparatus according to claim 13, wherein acquiring description information of a network resource comprises:
preprocessing original description information of the network resource.

15. (canceled)

16. The apparatus according to claim 13, wherein performing the explicit-term extraction procedure on the description information to extract the explicit term from the description information comprises:
loading a preset explicit term rule; and
extracting an information segment based on the explicit term rule from the description information and using the information segment as the explicit term.

17.-18. (canceled)

19. The apparatus according to claim 13, wherein performing the mode-term extraction procedure on the description information to extract the implicit term from the description information comprises:
loading a preset mode combination rule; and
extracting an information segment based on the mode combination rule from the description information and using the information segment as the implicit term.

20.-24. (canceled)

25. A non-transitory computer readable medium that stores a set of instructions that is executable by at least one processor of a computer to cause the computer to perform a term extraction method, the method comprising:
acquiring description information of a network resource;
performing an explicit-term extraction procedure on the description information to extract an explicit term from the description information; and
performing a mode-term extraction procedure on the description information to extract an implicit term from the description information.

26. The non-transitory computer readable medium according to claim 25, wherein acquiring description information of a network resource comprises:
preprocessing original description information of the network resource.

27. (canceled)

28. The non-transitory computer readable medium according to claim 25, wherein performing the explicit-term extraction procedure on the description information to extract the explicit term from the description information comprises:
loading a preset explicit term rule; and
extracting an information segment based on the explicit term rule from the description information and using the information segment as the explicit term.

29.-30. (canceled)

31. The non-transitory computer readable medium according to claim 25, wherein performing the mode-term extraction procedure on the description information to extract the implicit term from the description information comprises:
loading a preset mode combination rule; and
extracting an information segment based on the mode combination rule from the description information and using the information segment as the implicit term.

32.-36. (canceled)
